(19) United States
(12) Patent Application Publication
(10) Pub. No.: US 2026/0259848 A1
(43) Pub. Date: Sep. 3, 2026

(54) Software-Based Hot Plug Controller for Multi-Function Device

(71) Applicant: Marvell Asia Pte Ltd, Singapore (SG)

(72) Inventors: Jerin Jacob Kollanukkaran, Bengaluru (IN); Shijith Thotton, Payyanur (IN)

(21) Appl. No.: 19/454,069

(22) Filed: Jan. 20, 2026

Related U.S. Application Data
(60) Provisional application No. 63/748,592, filed on Jan. 23, 2025.

(51) Int. Cl. G06F 13/42

(52) U.S. Cl. CPC G06F 13/4221; G06F 2213/0026

(57) ABSTRACT

A method of facilitating insertion of a device into, or removal of a device from, a bus architecture of a computer system while the computer system is operational, comprises configuring a first function of a device of the computer system as a control function to control insertion and removal of at least one additional function from the bus architecture, and sending, by the device of the computer system to a host driver of a host computer, a binding command to bind the control function to the host driver. The method may further comprise configuring the at least one additional function for insertion into the bus architecture, sending, by the control function to the host driver, a request to insert the at least one additional function into the bus architecture, and enabling, by the host driver, the at least one additional function in response to the request.

### RELATED APPLICATIONS

This application claims the benefit of U.S. Provisional Application No. 63/748,592, filed on Jan. 23, 2025. The entire teachings of the above application are incorporated herein by reference.

### BACKGROUND

Peripheral Component Interconnect (PCI) Express, typically referred to as PCIe, is a high-speed bus standard used to connect hardware components in an electronics architecture such as a computer system. PCIe may be used to connect expansion devices, for example, graphics cards, sound cards, network cards, and storage devices such as solid-state drives and hard disk drives.

PCIe hot-plug is a technology that allows compatible PCIe devices to be inserted into or removed from an electronics system while that system is running, without needing to deactivate or otherwise shut down the system. hot-plugging is achieved through a coordinated process between hardware (e.g., a motherboard and an endpoint device) and software (such as an operating system and associated drivers) that safely powers the device up or down.

The current PCIe specification requires hot-plug support to be implemented on the upstream port, such as a Root Port or a Switch Downstream Port and the endpoint device. Implementing a PCIe switch, however, is a complex endeavor that requires commitment and support of additional hardware resources.

FIG. 1A illustrates a basic PCIe topology from the prior art. The root complex device (host) 102 connects the CPU and memory subsystem to the PCI Express switch fabric that consists of one or more PCIe devices 104.

FIG. 1B illustrates a typical PCIe hot-plug implementation in prior art systems. A data processing unit 106 hosts a hardware hot-plugging switch 108 and associated controller circuitry, and slots for n PCIe devices 110₁ through 110ₙ. A root port 112 of the root complex device 102 connects to the DPU 106 through PCIe fabric 114. A host driver at the root complex device 102 works with the hardware switch 108 to activate and enable one or more of the n PCIe devices 110₁ through 110ₙ and coordinates a hot insertion or hot-removal of one or more of the PCIe devices 110₁ through 110ₙ.

### SUMMARY

The embodiments described herein are directed to a system for and method of establishing a PCIe hot-plug implementation without a hardware PCIe switch.

In one aspect, the invention may be a method of facilitating insertion of a device into, or removal of a device from, a bus architecture of a computer system while the computer system is operational. The method may comprise configuring a first function of a multi-function device of the computer system as a control function to control insertion and removal of at least one additional function from the bus architecture. Each of the first function and the at least one additional function may represent a configurable capability of the multi-function device. The method may further comprise sending, by the device of the computer system to a host driver of a host computer, a binding command to bind the control function to the host driver. The method may further comprise configuring the at least one additional function to a state that is suitable for insertion into the bus architecture, sending, by the control function to the host driver, a request to insert the at least one additional function into the bus architecture, and enabling, by the host driver, the at least one additional function in response to the request to enable the at least one additional function. The enabling occurs without use of a hardware switch to separate the at least one additional function from the bus architecture.

The method may further comprise receiving, by the control function, a request to remove the at least one additional function from the bus architecture, sending, by the control function to the host driver, the request to remove the at least one additional function from the bus architecture, and disabling, by the host driver, the at least one additional function in response to the request to remove the at least one additional function from the bus architecture.

The bus architecture may be a Peripheral Component Interconnect Express® (PCIe®). The method may further comprise provisioning the device as a multi-function PCIe® endpoint. The method may further comprise provisioning the driver as a PCIe® vendor hot-plug system driver. The method may further comprise, upon binding the control function to the driver, logically removing, by the driver, the at least one additional function from the host. A network firmware component (i) may configure the at least one additional function for insertion into the bus architecture, and (ii) may generate the request to insert the at least one additional function into the bus architecture.

In another aspect, the invention may be a system that facilitates insertion of a device into, or removal of a device from, a bus architecture of a computer system while the computer system is operational. The system may comprise a device that has a first function and at least one additional function, the first function may be configured as a control function to control insertion and removal of at least one additional function from the bus architecture. The system may further comprise a computer system host and a driver of the computer system host that binds to the control function and communicates with the control function to manage insertion of the at least one additional function into the bus architecture of the computer system.

The driver of the computer system host may communicate with the control function to (i) configure the at least one additional function for insertion into the bus architecture, (ii) convey, from the control function to the driver, a request to insert the at least one additional function into the bus architecture, and (iii) enable, by the driver, the at least one additional function in response to the request to insert the at least one additional function.

The driver of the computer system host may communicate with the control function to (i) convey, from the control function to the driver, a request to remove the at least one additional function from the bus architecture, and (ii) disable, by the driver, the at least one additional function in response to the request to remove the at least one additional function from the bus architecture. The bus architecture may be a Peripheral Component Interconnect Express® (PCIe®). The device may be a multi-function PCIe® endpoint. The driver may be a PCIe® vendor hot-plug system driver. The driver of the computer system host may communicate with the control function to, upon binding the control function to the driver, logically remove the at least one additional function from the host. A network firmware component may (i) configure the at least one additional function for insertion into the bus architecture, and (ii) generate the request to insert the at least one additional function into the bus architecture.

In another aspect, the invention may be method of facilitating insertion of a device into, or removal of a device from, a bus architecture of an electronics system without deactivating the electronics system. The method may comprise configuring a first function of a multi-function device of the electronics system as a control function to control insertion and removal of a second function from the bus architecture. Each of the first function and the second function may represent a configurable capability of the multi-function device. The method may further comprise sending, by the device of the electronics system to a host driver of a central controller, a binding command to bind the control function to the host driver. The method may further comprise configuring the second function to a state that is for insertion into the bus architecture, sending, by the control function to the host driver, a request to insert the second function into the bus architecture, and enabling, by the host driver, the second function in response to the request to enable the second function, the enabling occurring without use of a hardware switch to separate the second function from the bus architecture.

The method may further comprise receiving, by the control function, a request to remove the second function from the bus architecture, sending, by the control function to the host driver, the request to remove the second function from the bus architecture, and disabling, by the host driver, the second function in response to the request to remove the second function from the bus architecture. The bus architecture may be Peripheral Component Interconnect Express® (PCIe®). The method may further comprise provisioning the device as a multi-function PCIe® endpoint. The method may further comprise provisioning the host driver as a PCIe® vendor hot-plug system driver.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A illustrates a basic PCIe topology from the prior art.

FIG. 1B illustrates a typical PCIe hot-plug implementation in prior art systems.

FIG. 1C illustrates the basic topology of the described embodiments.

FIG. 2 illustrates an example implementation of the hot-plugging of the described embodiments.

FIG. 3 shows a timeline for example hot-plugging operation in the example embodiment.

FIG. 4 illustrates an alternative view of the example embodiment executing the example procedure described in FIG. 3.

FIG. 5 shows a flow diagram that describes operation of the example embodiment described herein.

### DETAILED DESCRIPTION

A description of example embodiments follows.

The described embodiments are directed to a system for, and method of, establishing a PCIe hot-plug implementation without a hardware PCIe switch. In cases for which hot-plug capability is not implemented through a hardware switch), the root port and the endpoint device needs to support hot-plug aspects of the PCIe specification. Not all the motherboards support hot-pluggable Root port

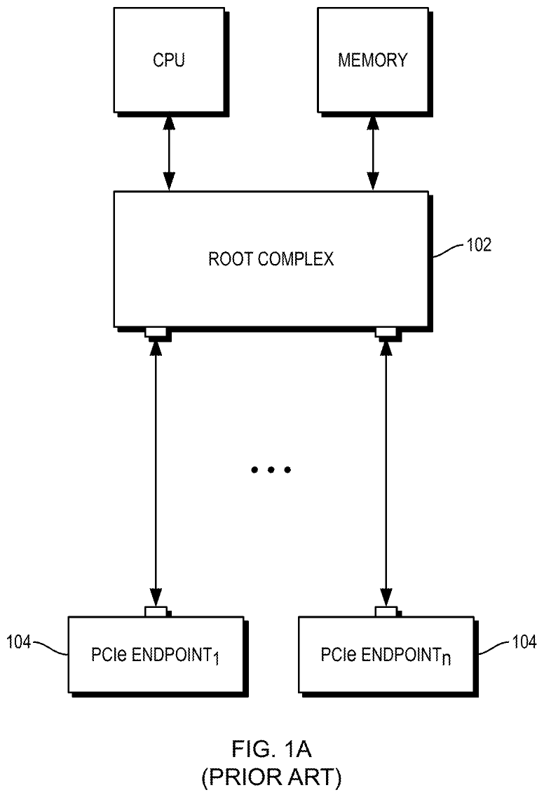

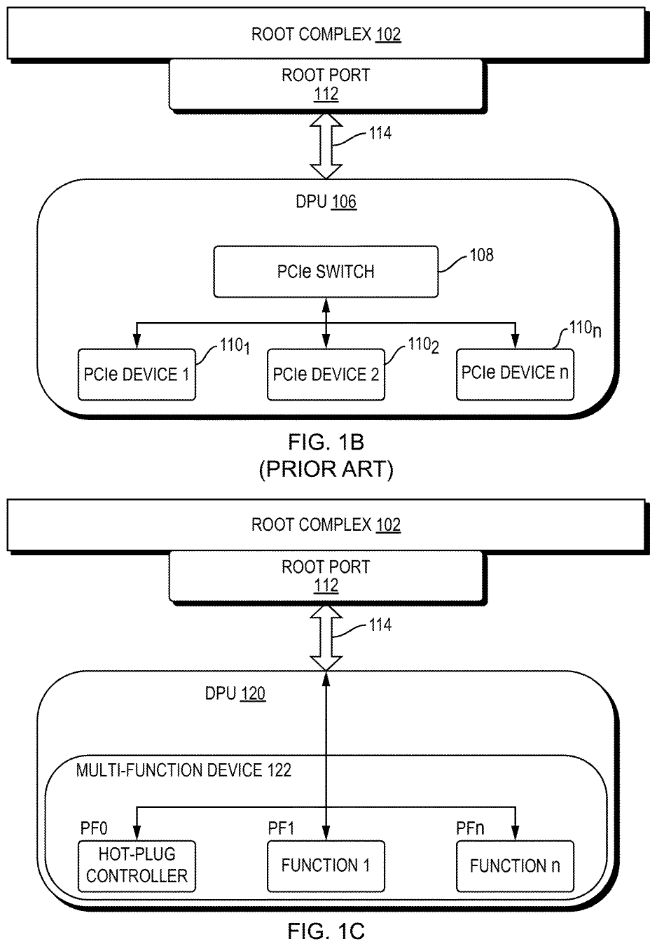

FIG. 1C illustrates the basic topology of the described embodiments. The DPU 120 hosts a multi-function device 122. The root port 112 of the root complex device 102 connects to the DPU 120 and to the multi-function device 122 through PCIe fabric 114. The PCIe multi-function device 122 is a single physical PCIe card or chip that behaves like several independent devices (e.g., a network card plus a sound card), appearing to the root complex device 102 as separate physical functions (e.g., PF0, PF1), each with their own config space and resources, which simplifies management and enabling features for virtualization, allowing one physical device to present multiple virtual ones. In the example embodiment described herein, the multi-function device 122 includes eight functions (PF0 through PF7), although in general the multi-function device 122 may consist of more functions (e.g., PF0 through PFn). In the described embodiments, the first function, PF0, provides hot-plug controller services.

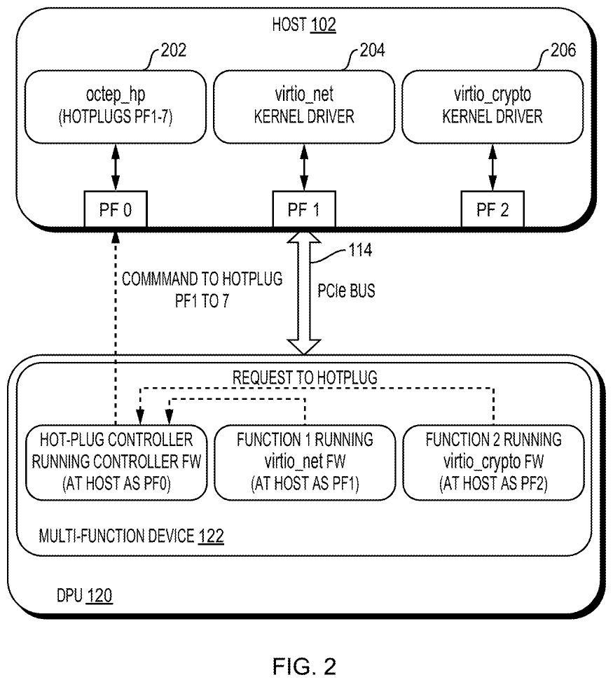

FIG. 2 illustrates an example implementation of the hot-plugging of the described embodiments. The root complex device 102 hosts the hot-plug driver 202, a virtual network interface device driver 204, and a virtual crypto device driver 206. Through the PCIe fabric 114, the hot-plug controller at PF0 communicates with the hot-plug driver 202 to coordinate hot-plug insertion or hot-plug removal of the virtual interface device and/or virtual crypto device at PF1 and PF2, respectively. The communication between the hot-plug controller PF0 and the hot-plug driver 202 is essentially a sideband signal implemented within the PCIe fabric.

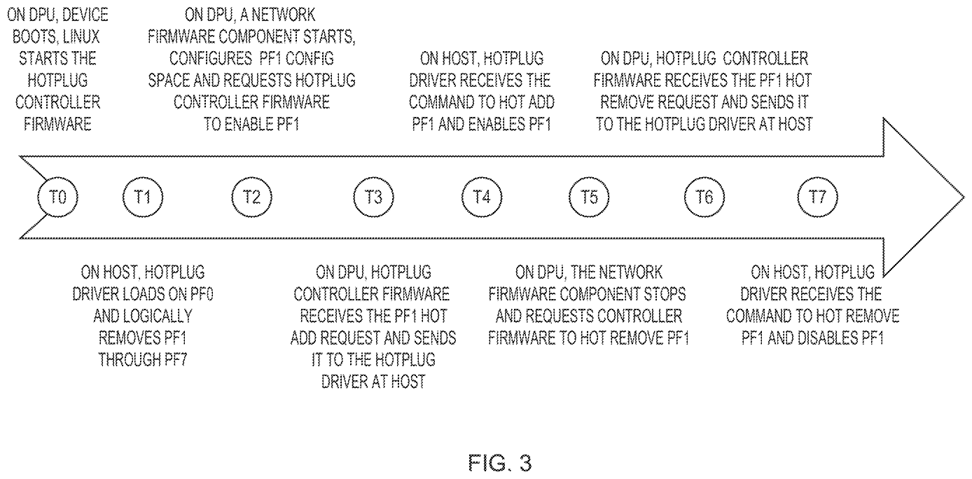

FIG. 3 shows a timeline for an example hot-plugging operation according to an embodiment of the present invention. At time T0, the DPU 120 boots and the local operating system (Linux) starts execution of the hot-plug firmware. At time T1, the hot-plug driver at the root complex device 102 loads on PF0 and logically removes virtual devices at PF1 through PF7. At time T2, a network firmware component at the DPU starts execution, configures PF1 config space, and requests the hot-plug controller at PF0 of the multi-function device 122 to enable PF1 (the virtual network interface device driver (virtio_net) 204 in this example embodiment).

Time T3 represents the beginning of the procedure to hot-add PF1. As described herein, the function PF1 emulates a PCIe device in this example embodiment. The “hot-add” of PF1 refers to the act of introducing PF1 device into the PCIe bus without powering down or otherwise halting the CPU at the root complex device 102 of the PCIe system. The hot-plug controller at PF0 receives the PF1 hot-add request from the network firmware component. The “PF1 hot-add request” represents a query message that facilitates introduction of the PF1 device into the PCIe bus without powering down or otherwise halting the CPU. and sends the hot-add request as a command to the hot-plug driver at the root complex device 102. At time T4, the hot-plug driver at the Root complex device 102 receives the command to hot-add PF1 and, in response, subsequently enables PF1.

Time T5 represents the beginning of the procedure to hot-remove PF1. The “hot-remove” of PF1 refers to the act of withdrawing the PF1 device from the PCIe bus without powering down or otherwise halting the CPU at the root complex device 102 of the PCIe system. The network firmware component on the DPU 120 stops and provides a FP1 hot-remove request to the hot-plug controller PF0. The “PF1 hot-remove request” represents a query message that facilitates withdrawal of the PF1 device from the PCIe bus without powering down or otherwise halting the CPU. At time T6, the hot-plug controller at PF0 on the DPU 120 receives the PF1 hot-remove request from the network firmware component and sends it as a command to the hot-plug driver at the root complex device 102. At time T7, the hot-plug driver at the root complex device 102 receives the hot-remove command and, in response, disables PF1.

The described embodiments reduce complexity of hot-plugging operations because they eliminate the need for a hardware PCIe switch at the PCIe endpoint device. The embodiments described also facilitate lower power consumption. Since only the required functions are active, power usage may be reduced by selectively enabling those required functions. The described embodiments further facilitate flexibility, because the runtime personality changes for each function based on the firmware component running on the host. The described embodiments facilitate a simplified design, which reduces hardware costs. The described embodiments facilitate scalability because they easily adapt to multiple virtual personalities without requiring additional hardware changes.

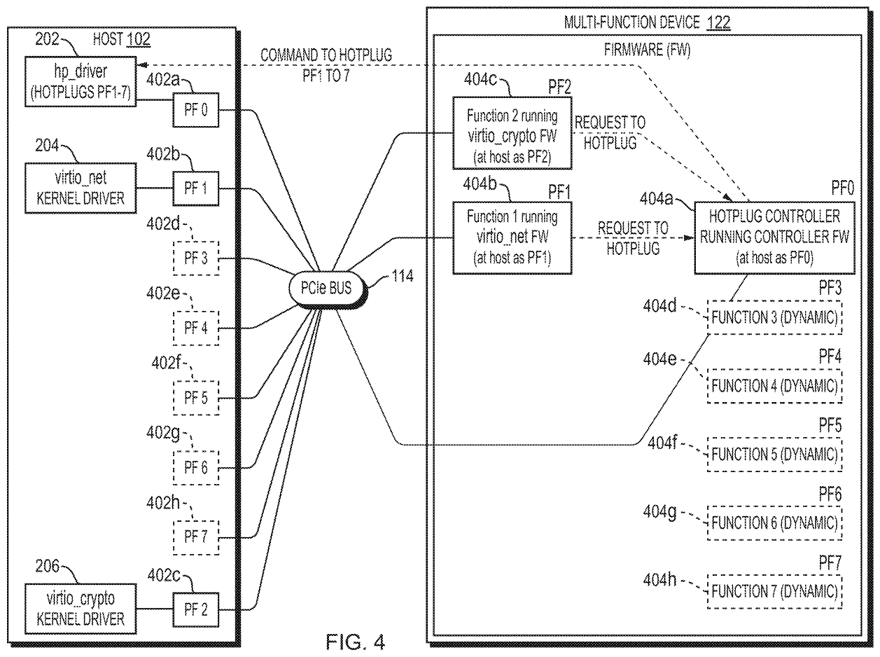

FIG. 4 illustrates an alternative view of the example embodiment executing the example procedure described in FIG. 3. The host 102 is shown with PCIe links 402a-402h to functions PF0 through PF7. With the hot-plug driver 202 coupled to PF0 link 402a, virtual network interface device driver 204 coupled to PF1 link 402b, and virtual crypto device driver 206 coupled to PF2 link 402c. The multi-function device 122 on the DPU is shown with function PF0 404a, function PF1 404b, function PF2 404c, and functions PF3 through PF7 404d-404h. As described with respect to FIG. 3, the multi-function device 122 at the DPU boots, Linux starts the firmware on hot-plug controller at PF0 404a. On the host 102, hot-plug driver 202 loads on PF0 402a and logically removes PF1 through PF7 404b-404h.

hot-plug add procedure. On the DPU, a network firmware component starts, configures PF1 config space, and requests hot-plug controller firmware at PF0 404a to enable PF1 404b (i.e., a hot-plug add request). The hot-plug controller firmware at PF0 404a receives the hot-plug add request for PF1 and, in response, sends a hot-add command for PF1 to the hot-plug driver 202 at the host. The hot-plug driver 202 receives the hot-add command and, in response, enables function PF1 404b.

hot-plug remove procedure. On the DPU, the network firmware component stops and sends the hot-plug controller firmware at PF0 404a a request to hot-remove PF1 404b. The hot-plug controller firmware at PF0 404a receives the request to hot-remove PF1 404b and, in response, sends a hot-plug remove command to the hot-plug driver 202 at the host. The hot-plug driver receives the hot-remove command and, in response, disables PF1 404b.

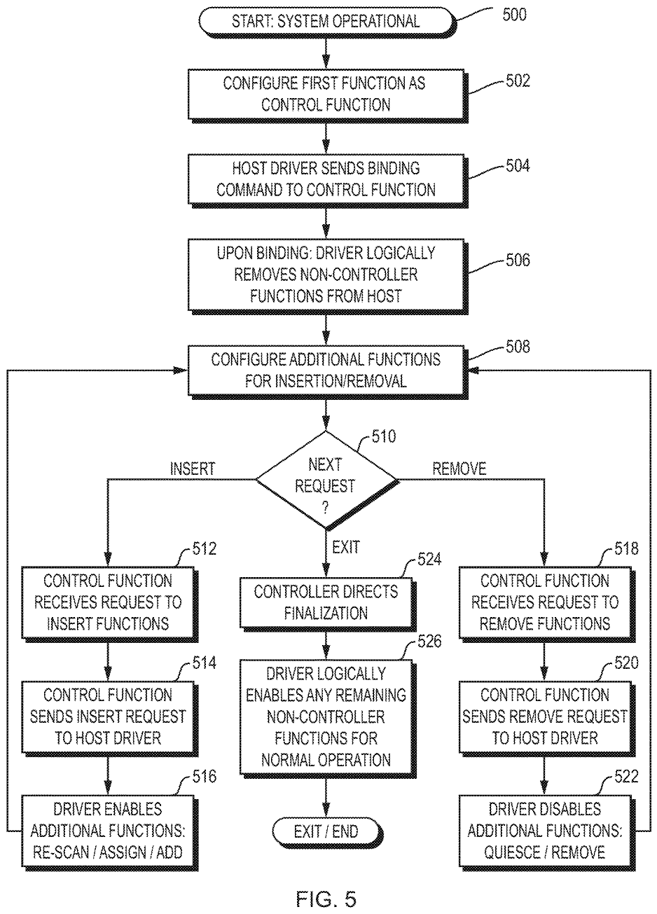

FIG. 5 shows a flow diagram that describes operation of the example embodiment described herein. Once the system is operational 500, the first function, PF0, is configured 502 as the hot-plug controller. The hot-plug driver at the host sends 504 a binding command to the hot-plug controller at PF0. Upon binding, the hot-plug driver logically removes 506 non-controller functions PF1 through PF7 from the host. Additional functions may then be configured 508 for insertion or removal.

If the next request 510 is determined to be a hot insertion (i.e., add) request, the hot-plug controller at PF0 receives 512 the hot-add request to add a function PF1 to PF7. The hot-plug controller at PF0 responds to the hot-add request by sending 514 a hot-add command to the hot-plug driver at the host. The hot-plug driver responds to the hot-add command by enabling 516 the function associated with the hot-plug add command, and returns to configure 508 an additional function.

If the next request is determined to be a hot-remove request, the hot-plug controller at PF0 receives 518 the hot-remove request to remove a function PF1 to PF7. The hot-plug controller at PF0 responds to the hot-remove request by sending 520 a hot-remove command to the hot-plug driver at the host. The hot-plug driver responds to the hot-add command by disabling 522 the function associated with the hot-plug remove command and returns to configure 508 an additional function.

If it is determined 510 that no further add or remove requests are pending, the hot-plug controller directs 524 finalization of the hot-add and/or remove procedure, and the hot-plug driver logically enables 526 any remaining non-hot-plug controller functions for normal operation.

While example embodiments have been particularly shown and described, it will be understood by those skilled in the art that various changes in form and details may be made therein without departing from the scope of the embodiments encompassed by the appended claims.

What is claimed is:

1. A method of facilitating insertion of a device into, or removal of a device from, a bus architecture of a computer system while the computer system is operational, comprising:
configuring a first function of a multi-function device of the computer system as a control function to control insertion and removal of at least one additional function from the bus architecture, each of the first function and the at least one additional function represents a configurable capability of the multi-function device;
sending, by the device of the computer system to a host driver of a host computer, a binding command to bind the control function to the host driver;
configuring the at least one additional function to a state that is suitable for insertion into the bus architecture;
sending, by the control function to the host driver, a request to insert the at least one additional function into the bus architecture; and
enabling, by the host driver, the at least one additional function in response to the request to enable the at least one additional function, the enabling occurring without use of a hardware switch to separate the at least one additional function from the bus architecture.

2. The method of claim 1, further comprising:
receiving, by the control function, a request to remove the at least one additional function from the bus architecture;
sending, by the control function to the host driver, the request to remove the at least one additional function from the bus architecture; and
disabling, by the host driver, the at least one additional function in response to the request to remove the at least one additional function from the bus architecture.

3. The method of claim 1, wherein the bus architecture is Peripheral Component Interconnect Express® (PCIe®).

4. The method of claim 3, further comprising provisioning the device as a multi-function PCIe® endpoint.

5. The method of claim 3, further comprising provisioning the driver as a PCIe® vendor hot-plug system driver.

6. The method of claim 1, further comprising, upon binding the control function to the driver, logically removing, by the driver, the at least one additional function from the host.

7. The method of claim 1, wherein a network firmware component (i) configures the at least one additional function for insertion into the bus architecture, and (ii) generates the request to insert the at least one additional function into the bus architecture.

8. A system that facilitates insertion of a device into, or removal of a device from, a bus architecture of a computer system while the computer system is operational, comprising:
a device that has a first function and at least one additional function, the first function configured as a control function to control insertion and removal of at least one additional function from the bus architecture;
a computer system host; and
a driver of the computer system host that binds to the control function and communicates with the control function to manage insertion of the at least one additional function into the bus architecture of the computer system.

9. The system of claim 8, wherein the driver of the computer system host communicates with the control function to:
(i) configure the at least one additional function for insertion into the bus architecture;
(ii) convey, from the control function to the driver, a request to insert the at least one additional function into the bus architecture; and
(iii) enable, by the driver, the at least one additional function in response to the request to insert the at least one additional function.

10. The system of claim 8, wherein the driver of the computer system host communicates with the control function to:
(i) convey, from the control function to the driver, a request to remove the at least one additional function from the bus architecture; and
(ii) disable, by the driver, the at least one additional function in response to the request to remove the at least one additional function from the bus architecture.

11. The system of claim 8, wherein the bus architecture is Peripheral Component Interconnect Express® (PCIe®).

12. The system of claim 11, wherein the device is a multi-function PCIe® endpoint.

13. The system of claim 11, wherein the driver is a PCIe® vendor hot-plug system driver.

14. The system of claim 8, wherein the driver of the computer system host communicates with the control function to, upon binding the control function to the driver, logically remove the at least one additional function from the host.

15. The system of claim 8, wherein a network firmware component (i) configures the at least one additional function for insertion into the bus architecture, and (ii) generates the request to insert the at least one additional function into the bus architecture.

16. A method of facilitating insertion of a device into, or removal of a device from, a bus architecture of an electronics system without deactivating the electronics system, comprising:
configuring a first function of a multi-function device of the electronics system as a control function to control insertion and removal of a second function from the bus architecture, each of the first function and the second function represents a configurable capability of the multi-function device;
sending, by the device of the electronics system to a host driver of a central controller, a binding command to bind the control function to the host driver;
configuring the second function to a state that is for insertion into the bus architecture;
sending, by the control function to the host driver, a request to insert the second function into the bus architecture; and
enabling, by the host driver, the second function in response to the request to enable the second function, the enabling occurring without use of a hardware switch to separate the second function from the bus architecture.

17. The method of claim 16, further comprising:
receiving, by the control function, a request to remove the second function from the bus architecture;
sending, by the control function to the host driver, the request to remove the second function from the bus architecture; and
disabling, by the host driver, the second function in response to the request to remove the second function from the bus architecture.

18. The method of claim 16, wherein the bus architecture is Peripheral Component Interconnect Express® (PCIe®).

19. The method of claim 18, further comprising provisioning the device as a multi-function PCIe® endpoint.

20. The method of claim 18, further comprising provisioning the host driver as a PCIe® vendor hot-plug system driver.
